(19) United States
(12) Patent Application Publication
(10) Pub. No.: US 2009/0040106 A1
(43) Pub. Date: Feb. 12, 2009

(54) Cellular Antennas and Communications Methods

(76) Inventors: Quoc M. Le, Plano, TX (US); Gerry Sarver, Plano, TX (US)

Correspondence Address: WELSH & KATZ - COMMSCOPE, INC., 120 S. RIVERSIDE PLAZA, 22ND FLOOR, CHICAGO, IL, 60606, US

(21) Appl. No.: 12/196,054

(22) Filed: Aug. 21, 2008

Related U.S. Application Data
(63) Continuation-in-part of application No. 11/753,762, filed on May 25, 2007.

(51) Int. Cl. H01Q 3/00

(52) U.S. Cl. 342/372

(57) ABSTRACT

An antenna includes a number of controllers and a number of peripheral devices. A first controller is configured to communicate commands and/or data between the antenna and a device outside of the antenna, such as a remote controller. The controllers are configured to communicate commands and/or data and to control the peripheral devices.

### FIELD OF THE INVENTION

The invention relates to antennas and to communications methods. In particular, but not exclusively, the invention relates to cellular antennas and to communications methods used in such antennas. The communications methods may be used for communication of control data or control of peripheral devices.

### BACKGROUND TO THE INVENTION

Cellular antennas are generally controlled by base station controllers. Each antenna may have an interface for receiving control signals from the base station controller and an antenna controller for receiving the control signals and controlling antenna actuators and the like in accordance with the control signals.

The antenna controller must be capable of controlling each antenna actuator. Furthermore, where sensors are used for monitoring antenna characteristics, the antenna controller must also be capable of communicating with each sensor.

This is problematic because, as antennas become more complex, several peripheral devices such as actuators and sensors are included in the antenna. The antenna controller must be capable of controlling and/or communicating with all of these devices. This not only requires a more sophisticated controller, but also makes retrofitting a new peripheral device into an antenna difficult and time-consuming.

It is an object of the invention to provide improved communications and control systems within antennas. It is another object of the invention to provide a standard communications interface for peripheral devices. It is a further object of the invention to provide a plug and play system for peripheral devices.

### EXEMPLARY EMBODIMENTS

There is provided an antenna including a number of controllers and a number of peripheral devices. A first controller is configured to communicate commands and/or data between the antenna and a device outside of the antenna, such as a remote controller. The controllers are configured to communicate commands and/or data and to control the peripheral devices.

In a first exemplary embodiment there is provided an antenna including: a plurality of peripheral devices configured to monitor or adjust one or more attributes of the antenna; and

a plurality of controllers each associated with one or more of the peripheral devices;

wherein a first controller of the plurality of controllers is configured to:

communicate commands or data between the antenna and a remote controller;

control a first peripheral device; and

communicate commands or data with others of the plurality of controllers.

In a second exemplary embodiment there is provided a controller for installation in an antenna, including:

a first interface for communicating commands or data between an antenna in which the controller is installed and a remote controller; and

a second interface for communicating commands or data with further controllers installed within the antenna;

wherein the controller is configured to control a first peripheral device within the antenna for monitoring or adjustment of one or more attributes of the antenna.

In a third exemplary embodiment there is provided an antenna including:

a plurality of peripheral devices configured to monitor or adjust one or more attributes of the antenna; and

an internal network including a plurality of distributed intelligent devices, the distributed intelligent devices including:

a first device configured to communicate commands or data between the antenna and a remote controller and to communicate commands or data with other distributed intelligent devices in the internal network; and

one or more controllers each associated with one or more of the peripheral devices and configured to communicate commands or data with the first device.

In a fourth exemplary embodiment there is provided an antenna including:

a plurality of peripheral devices configured to monitor or adjust one or more attributes of the antenna;

a plurality of controllers each associated with one or more of the peripheral devices;

wherein at least one of the controllers is configured to receive an adjustment attribute command and to control an actuator in accordance with the adjustment attribute command.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a cellular antenna according to one embodiment;

FIG. 2 shows a communications packet structure;

FIG. 3 shows a first controller in greater detail;

FIG. 4 shows a sub-controller according to one embodiment;

FIG. 5 shows a sub-controller according to a further embodiment;

FIG. 6 shows a base station according to a further embodiment;

FIG. 7 shows a base station according to another embodiment;

FIG. 8 shows a base station according to yet another embodiment;

FIG. 9 shows a base station according to a further embodiment;

FIG. 10 shows a base station according to another embodiment; and

FIG. 11 shows a base station according to yet another embodiment.

### DESCRIPTION OF EMBODIMENTS OF THE INVENTION

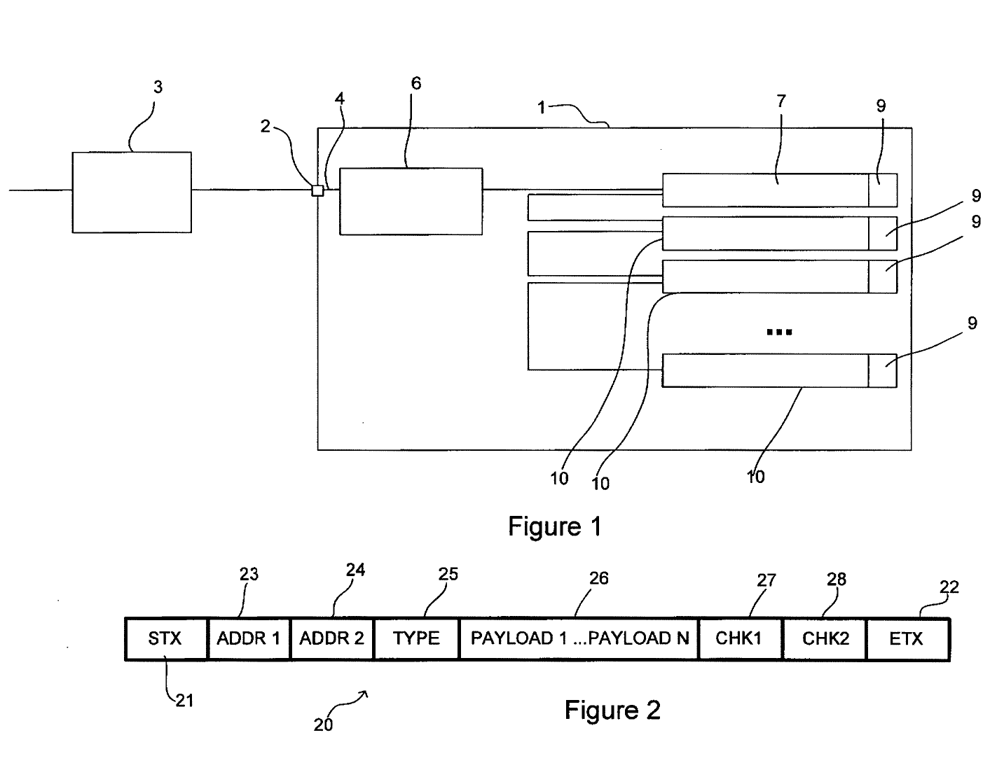

FIG. 1 is a schematic view of an antenna 1, which may be a cellular antenna, in particular a cellular base station antenna. FIG. 1 in general shows the control aspects of the antenna 1. The antenna also has a communications function, and so includes one or more antenna elements (not shown) for receiving and/or transmitting signals to wireless user devices.

The antenna 1 may include an interface 2 for communication of signals to and from an external controller 3. Although shown in FIG. 1, the external controller 3 will generally be situated remote from the antenna 1.

The interface 2 may be an Antenna Interface Standards Group (AISG) connector configured to connect an external AISG line (not shown) to an internal communications line 4. Alternatively, a RF signal interface could be provided, connecting an external RF communications line to an internal communications line. Many different types of interface 2 and communications line 4 may be suitable. Also, the interface could be a wired or wireless interface, receiving signals from a wired communications line, or over a wireless connection or optical connection.

Power for the antenna may be provided over the RF communications line by way of a bias T arrangement. Alternatively, power could be supplied by a separate power line or local supply (such as solar power etc).

Signals transmitted via the interface 2 over the communications line 4 may pass through a passive lightning protection module 6 and then on to a first controller 7.

The first controller may receive commands and other data from an external or remote controller, transmit data to the external or remote controller, transmit commands and other data to other internal controllers, receive data from other internal controllers and may also control a peripheral device, as described below.

The antenna may include one or more peripheral devices 9. In general, the peripheral devices 9 may be configured to monitor or adjust antenna attributes.

These devices may include one or more antenna actuator motors or drivers (including solenoid drivers), for adjustment of components such as phase shifters and mechanical components, for adjustment of antenna characteristics such as azimuth angle, downtilt angle and beam-forming characteristics (beam width, or more complex beam-forming characteristics, for example).

The peripheral devices 9 may include one or more sensors. The sensors may include one or more of: GPS receivers, inclinometers, azimuth angle sensors, position sensors including sensors for sensing component positions, angle sensors, phase sensors including electronic phase sensors, sun direction sensors (for determining antenna orientation), or any other sensors useful in antennas. The peripheral devices 9 may include one or more display devices, including displays (e.g. LCD displays) or indicators (e.g. simple LED indicators, or audible indicators such as buzzers).

The peripheral devices may be associated with sub-controllers 10. Each sub-controller 10 may be formed integrally as part of a peripheral device or may be formed separately and connected to the peripheral device by any suitable connection. Each sub-controller 10 may include a processor and is adapted to communicate with the first controller. In particular, the sub-controllers may be capable of interpreting control data and/or other data sent by the first controller. Each sub-controller may be associated with a single peripheral device. Alternatively, sub-controllers may be associated with one or more peripheral devices.

Use of sub-controllers 10 may allow a standard interface to be provided. Each sub-controller may be capable of communications with the first controller 7 over the communications bus described below. This means that peripheral devices (together with sub-controllers) can be added in a ‘plug and play’ manner, without any need for reconfiguring the first controller 7 to communicate with the new peripheral device.

The sub-controllers/peripheral devices may communicate with the first controller using a listen-first, talk-second protocol.

The peripheral devices may include devices which are serially addressable by means of address information in a data packet, such as that shown in FIG. 2. A data packet 20 may include a start octet 21 and an end octet 22.

Addressing may be implemented using two address octets 23, 24. These octets allow software addressing of the controller 7 or sub-controllers 10. Each octet may represent a hexadecimal numeric character, which may be in the range ‘0’ through ‘F’. This allows 256 distinct address codes to be formed. Each controller may be assigned a unique software address. Thus, a large number of devices within the antenna can be addressed.

A type octet 25 may be provided, allowing the use of a type code specifying a command or data type sent within the message. In addition, the value in the type octet 25 may itself constitute a command. For example, a type code “Q” may be sent with no payload. This may constitute a command to a sub-controller 10 to send certain current status values to the first controller 7. The sub-controller 10 may respond with a type code “q” and a payload containing information on the current status of the sub-controller 10 and/or a peripheral device 9 associated with that sub-controller 10.

The payload may be sent within one or more octets 26, for transmission of commands and/or data between the first controller 7 and the sub-controllers 10. Any suitable format may be used.

The commands supported by the first controller 7 and sub-controllers 10 may include antenna adjustment attribute commands governing the manner in which actuation is to be carried out.

In particular, peripheral devices such as phase shifters and mechanical angle adjusters generally include a motor. These may provide mechanical actuation using a threaded component, which can lead to so-called “backlash” errors arising from the thread.

It may therefore be desirable to ensure that any adjustment of the peripheral device is always completed in the same direction. This direction may be inwards, outwards, left, right, clockwise or counterclockwise, depending on the particular mechanism involved.

Furthermore, any adjustment in the opposite direction to the desired direction of movement may require that the mechanism “overshoots” the desired setting to a certain degree before returning to the desired setting in the desired direction of movement.

The adjustment attribute commands may include commands and/or data specifying a direction in which an actuator movement is to be completed. The adjustment attribute commands may also specify a level of overshoot. The level of overshoot may be specified using any suitable unit, including: inches, millimetres, angle, number of rotations etc.

The data packet 20 may also include a two octet checksum 27, 28 for error detection, as will be understood by a skilled reader.

The data packets may be entirely ASCII-based. Such a protocol is fairly simple to implement and requires only low level processing power for communications.

The first controller 7 may thus receive commands and/or data from outside the antenna and process these commands and/or data to form appropriate data packets for sending over the internal communications bus, using the internal communications protocol. Similarly, data sent by sub-controllers 10 to the first controller 7 over the internal communications standard may be processed by the first controller for communication (if required) to a remote controller, under whatever protocol is used for communications between the remote controller and the antenna.

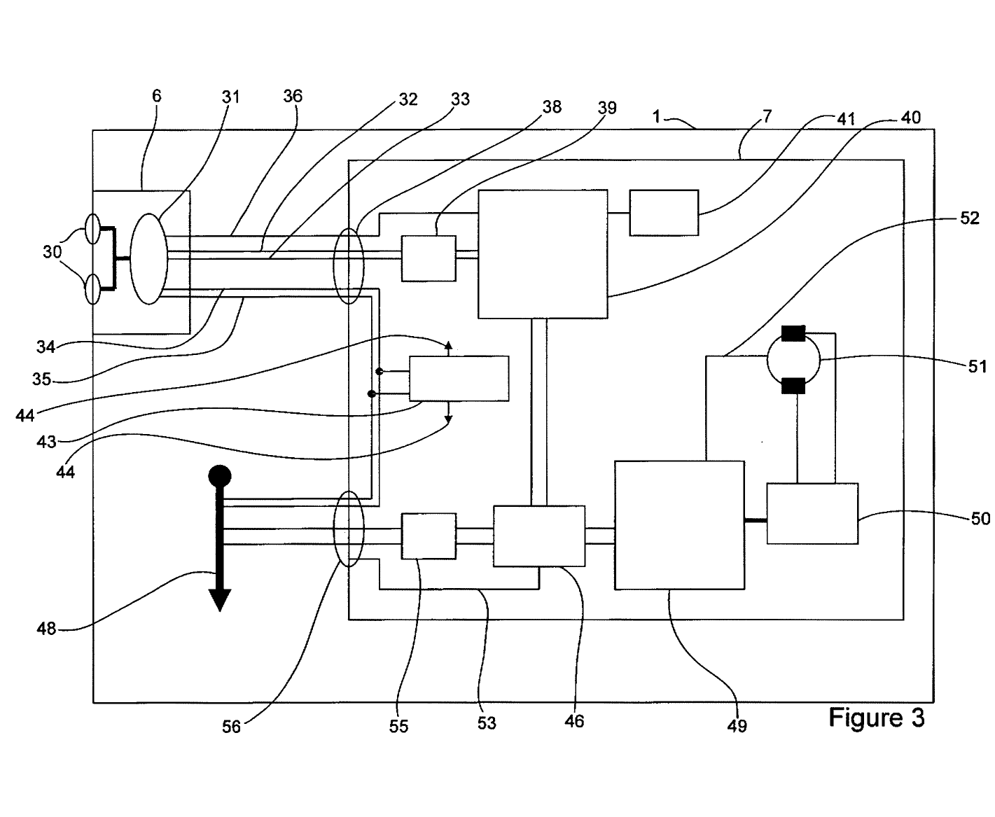

FIG. 3 is a further schematic diagram of the antenna 1, showing in more detail the lightning protection module 6 and the first controller 7.

The lightning protection module 6 may include an interface 30 for receiving signals from a remote controller (not shown in FIG. 3). The lightning protection module 6 may include a passive lightning protection circuit 31, connected both to the interface 30 and to a number of internal connections. These internal connections may include a pair of data lines 32, 33 and a pair of power lines 34, 35. In one embodiment the internal connections may also include an auxiliary line 36, which may be used, for example, to send LED toggle commands.

The first controller 7 may include an interface 38 for connection to the data, power and auxiliary lines 32-36. A data interface 39 may connect to the data lines 32, 33 and supply data to a main controller module 40. In general, data may be communicated between the first controller 7 and an external controller (not shown) in AISG-compliant form. Control data and/or commands may be embedded in Level 7 of an AISG-compliant protocol. AISG protocols for this external communication will be known to the skilled reader and are not described in detail in this specification.

The main controller module 40 may be an ARM-based controller, for example an ARM-based LPC2138 controller. The main controller module 40 may be connected to memory 41, for example serial EEPROM memory.

A power interface 43 may connect to the power lines 34, 35 and provides a suitable power supply to any devices within the first controller 7 requiring power. For clarity the power supply connections are not shown in FIG. 3, being indicated simply by arrows 44.

The auxiliary line 36 may be used to provide auxiliary signals (e.g. LED toggle commands) to the main controller module 40.

The main controller module 40 may be connected via a switch arrangement 46 to other components within the first controller 7 and also to an internal antenna peripheral bus 48. A slave peripheral controller module 49 may communicate with the main controller module 40 and control an actuator 50. The actuator in turn actuates a peripheral device 51.

Feedback from the peripheral device may be retrieved using suitable connections 52 to the peripheral controller module 49.

Thus, the main controller module 40 and peripheral controller module 49 may communicate commands and/or data via the switch arrangement 46.

The switch arrangement 46 may also be connected to a test line 53. This may be used during manufacturing for testing, or for fault detection in the field.

Finally, the switch arrangement 46 connects via communications interface 55 to an internal communications bus interface 56. The power lines 34, 35 also connect through this interface 56 in order to supply power to the internal communications bus 48.

Thus, the internal communications bus 48 may be a very simple bus, including a pair of data lines and a pair of power lines. Simple connections, such as RS485 connections, may be used.

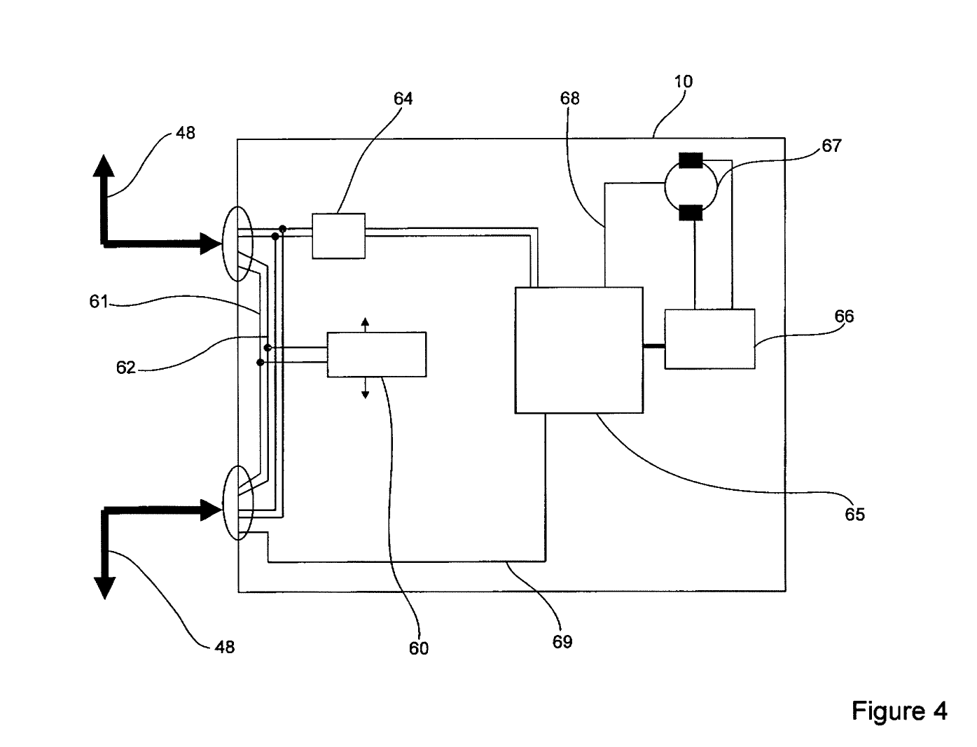

FIG. 4 shows one embodiment of a sub-controller 10 in more detail. The sub-controller 10 may receive power and commands and/or data over the internal communications bus 48. A power interface 60 may receive power from the internal communications bus 48 via power lines 61, 62 and may supply power to various components within the sub-controller 10. Again, the power connections are not shown for clarity.

A communications interface 64 may receive commands and/or data and provide these to a peripheral control module 65. The peripheral control module 65 may control an actuator 66, for actuation of a peripheral device 67. Again, feedback from the peripheral device may be received by the peripheral control module 65 over connection 68.

A test line 69 may again be provided, similar to the test line 53 of the first controller 7.

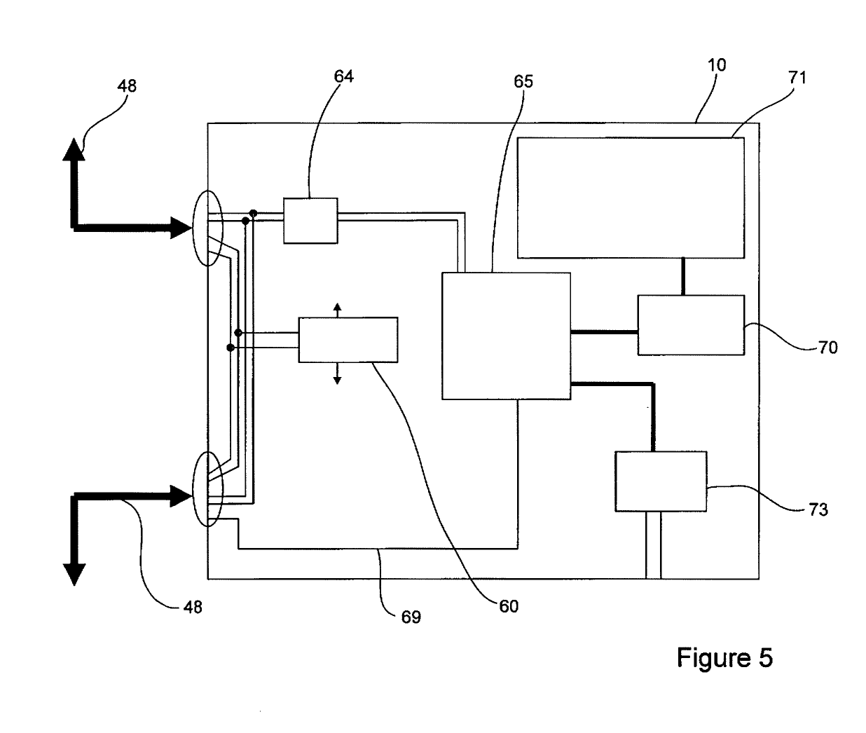

FIG. 5 shows a further embodiment of sub-controller 10. Here the peripheral control module 65 is connected to a display controller or driver 70, which drives a display 71, such as an LCD or LED display. The peripheral control module 65 may also be connected to a sensor interface 73, for connection to a desired sensor.

The sub-controllers of FIGS. 4 and 5 are suitable for connection in a daisy-chain configuration. However, any suitable connection configuration may be used.

In general, any form of commands and/or data may be sent over the internal communications bus 48. These may include commands and/or data relating to actuation, feedback, status, calibration, configuration, initialization and any other desired information or operation.

Device present signals may be sent from sub-controllers and/or peripheral devices to the first controller 7 to indicate their presence. Indicator signals may also be sent. These instruct operation of indicators, such as visual indicators (e.g. LEDs) or audible indicators (e.g. buzzers, speakers etc). This allows feedback on antenna operation when the antenna is enclosed within its housing.

Control instructions and other data may be sent to the first controller 7 from an external system. The first controller 7 then controls the functioning of the antenna in accordance with these signals. For example, the first controller 7 may send control or other data over the internal communications bus 48 to a sub-controller 10.

A schedule of required antenna operations may be maintained externally, with commands being sent to the antenna as required. Alternatively, a schedule could be sent to the antenna and maintained in the first controller 7, with the first controller 7 sending commands as required to the sub-controllers 10.

In general, the internal communications bus 48 links a number of distributed intelligent devices (including the first controller 7 and sub-controllers 10), thereby forming an internal network. This allows improved functionality, including simplified communications, plug-and-play capability, scalability, a standardised interface for addition of further sub-controllers 10 etc. The internal network may also allow improved processing capability within the antenna 1. For example, processing redundancy, parallel processing and/or load sharing techniques may be implemented within the antenna.

This promotes the efficient use of processing power within the antenna, which may reduce the processing load in particular controllers. This may also reduce communications loads because processing tasks can be performed within the antenna before sending data out of the antenna.

Furthermore, at least some of the distributed intelligent devices may perform processing functions for transmission or reception of radiofrequency signals via the antenna's beam (rather than, or in addition to processing functions relating to peripheral devices). For example, the processing power within the antenna could be used for pre-processing of received RF signals before transmitting received data from the antenna over an optical or wired link.

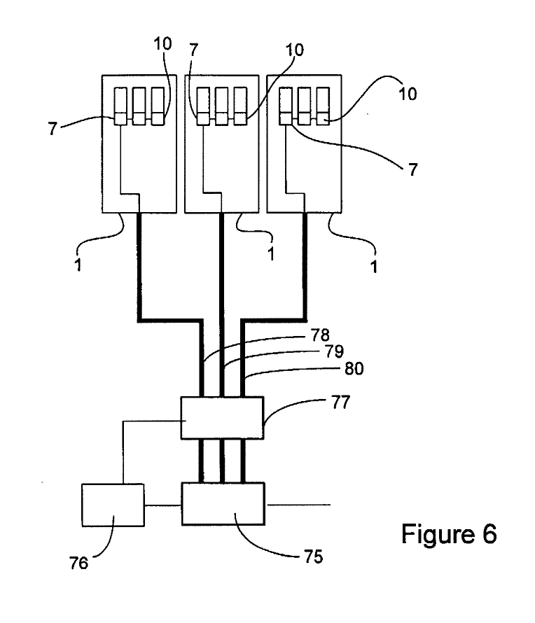

FIG. 6 is a schematic diagram of a base station including a number of antennas 1 such as those described above. The base station includes a base station controller 75 and an auxiliary equipment controller 76. The base station controller 75 provides RF signals to an interface 77, while the auxiliary equipment controller 76 provides command signals or other data to the interface 77. The interface 77 may use a modulation arrangement to overlay command and other data on the RF signals, so that both are sent to the appropriate antenna over a coaxial feed cable 78, 79, 80. Each antenna 1 is configured to separate the command and other data from the RF signals.

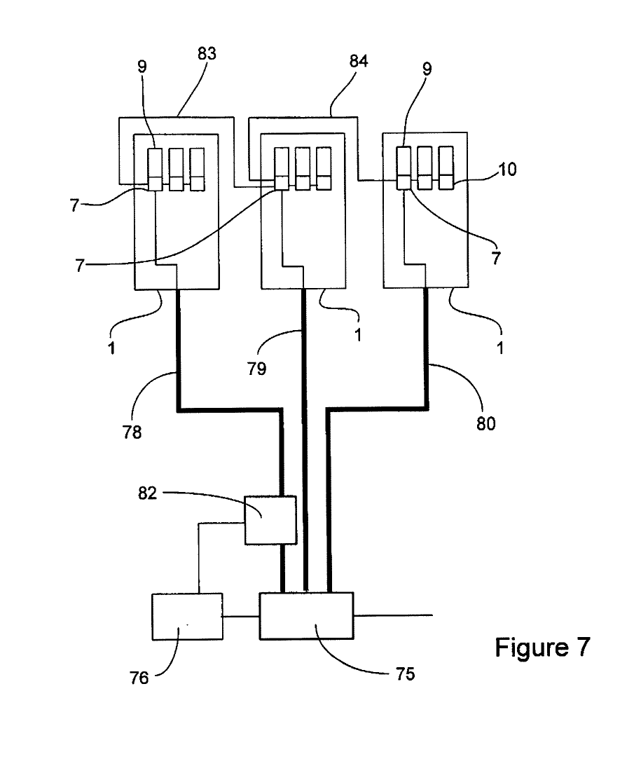

FIG. 7 shows an alternative base station arrangement. Command and other data is sent over only a first RF feed cable 78, using interface 82. The first controllers 7 of the antennas 1 may be connected in a daisy chain arrangement by ASIG compliant serial cables 83 and 84.

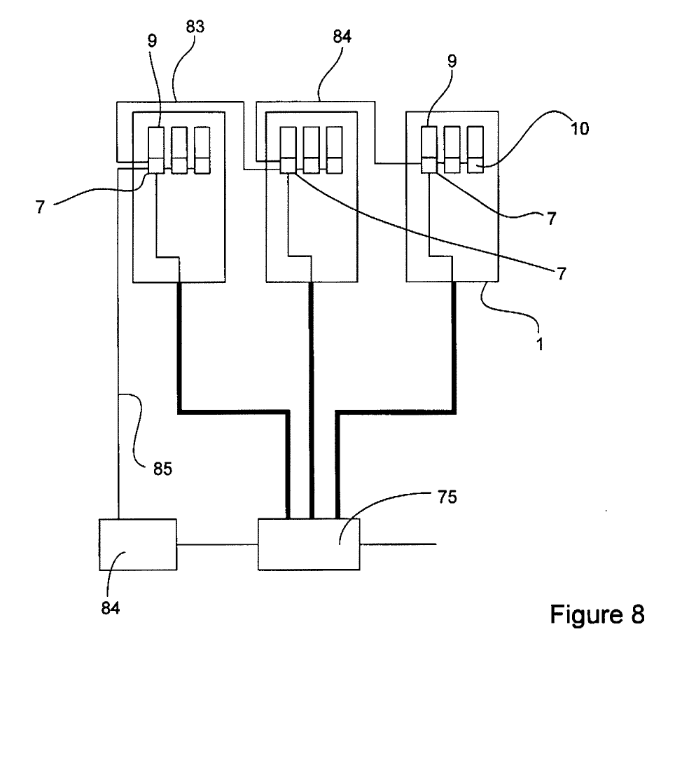

FIG. 8 shows a further alternative base station arrangement, in which the auxiliary equipment controller 84 communicates directly with the first controller 7 of one antenna over communications line 85. The other first controllers 7 are again connected by serial lines 83, 84 in a daisy chain arrangement.

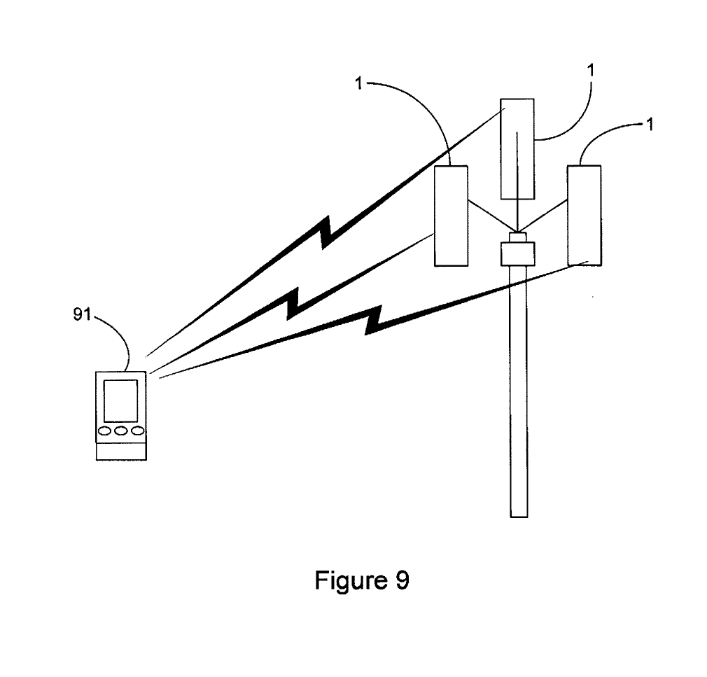

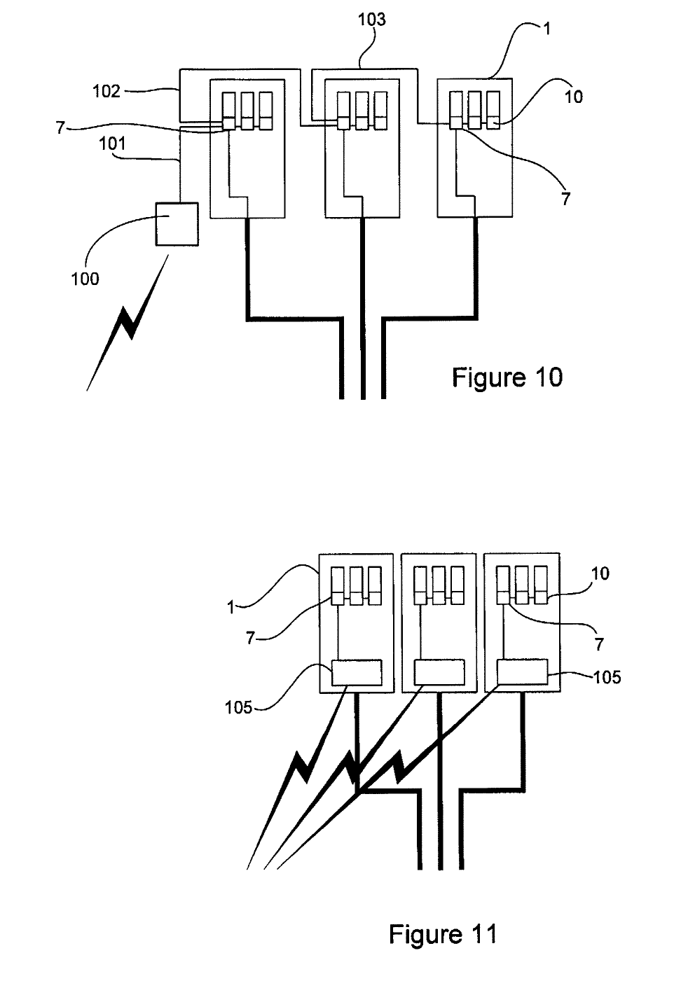

FIG. 9 shows another base station arrangement in which a wireless device 91, or a controller equipped with a wireless communications interface, communicates over a wireless link with the antennas 1. As shown in FIG. 10, the wireless device may communicate with a wireless receiver 100, which then communicates with the first controllers 7 of the antennas 1 using a serial ASIG compliant daisy chain arrangement 101, 102, 103. Alternatively, as shown in FIG. 11, the wireless device may communicate directly with each antenna 1. In this case each first controller 7 is configured to receive wireless signals, or is provided with a separate wireless receiver 105.

The systems and antennas described above are capable of controlling motorized actuation for electronic downtilt, azimuth panning and beam forming. They are also capable of operating displays, indicators and also sensors for detection of antenna position, orientation, phase values and the like. They provide ease of manufacturing, overall usage and installation of peripheral devices. They use cost-effective components for interconnections and the data bus.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An antenna including:
i. a plurality of peripheral devices configured to monitor or adjust one or more attributes of the antenna; and
ii. a plurality of controllers each associated with one or more of the peripheral devices;
wherein a first controller of the plurality of controllers is configured to:
a. communicate commands or data between the antenna and a remote controller;
b. control a first peripheral device; and
c. communicate commands or data with others of the plurality of controllers.

2. An antenna as claimed in claim 1 wherein the peripheral devices include one or more devices from the group consisting of: antenna actuators controlling azimuth angle, downtilt angle or beamwidth; GPS receivers; azimuth angle sensors; inclinometers; phase sensors; position sensors; phase shifters; mechanical drivers; motors; solenoid drivers, displays and indicators.

3. An antenna as claimed in claim 1 including one controller for each peripheral device.

4. An antenna as claimed in claim 1 wherein at least some of the controllers are integrated with peripheral devices.

5. An antenna as claimed in claim 1 wherein the first controller is configured to communicate commands or data between the antenna and a remote controller over a wired, wireless or optical link.

6. An antenna as claimed in claim 1 wherein the first controller is configured to communicate commands or data and address data in packet form when communicating with others of the plurality of controllers.

7. An antenna as claimed in claim 1 including an internal communications bus linking the first controller with the others of the plurality of controllers, the bus supporting an internal communications protocol for packetized, ASCII-based communications between the first controller and the others of the plurality of controllers, each of the plurality of controllers being uniquely software addressable on the internal communications bus.

8. An antenna as claimed in claim 7 wherein the internal communications bus is based around wired RS485 connections.

9. An antenna as claimed in claim 7 wherein the internal communications bus includes one or more power lines for supplying power to the controllers and/or peripheral devices and a pair of data lines for communication of commands and/or data.

10. An antenna as claimed in claim 7 wherein the internal communications bus allows plug and play connection of further controllers to the internal communications bus.

11. An antenna as claimed in claim 1 wherein the controllers are arranged in a daisy chain configuration.

12. An antenna as claimed in claim 1 wherein the first controller is configured to store a control schedule and to send commands or data over a period of time to others of the plurality of controllers in order to control peripheral devices in accordance with the control schedule.

13. An antenna as claimed in claim 1 wherein the plurality of controllers form an internal network.

14. An antenna as claimed in claim 1, the antenna being a cellular base station antenna.

15. A cellular base station including one or more antennas as claimed in claim 14 controlled by a common remote controller.

16. A controller for installation in an antenna, including:
i. a first interface for communicating commands or data between an antenna in which the controller is installed and a remote controller; and
ii. a second interface for communicating commands or data with further controllers installed within the antenna;
wherein the controller is configured to control a first peripheral device within the antenna for monitoring or adjustment of one or more attributes of the antenna.

17. An antenna as claimed in claim 16 wherein the first interface supports a first protocol and the second interface supports a second protocol different to the first protocol.

18. An antenna including:
i. a plurality of peripheral devices configured to monitor or adjust one or more attributes of the antenna; and
ii. an internal network including a plurality of distributed intelligent devices, the distributed intelligent devices including:
a. a first device configured to communicate commands or data between the antenna and a remote controller and to communicate commands or data with other distributed intelligent devices in the internal network; and
b. one or more controllers each associated with one or more of the peripheral devices and configured to communicate commands or data with the first device.

19. An antenna as claimed in claim 18 wherein the first device is also a controller associated with a peripheral device.

20. An antenna as claimed in claim 18 wherein the distributed intelligent devices are configured to cooperate for one or more of: redundancy, parallel processing or load sharing.

21. An antenna as claimed in claim 18 wherein the peripheral devices include one or more devices from the group consisting of: antenna actuators controlling azimuth angle, downtilt angle or beamwidth; GPS receivers; azimuth angle sensors; inclinometers; phase sensors; position sensors; phase shifters; mechanical drivers; motors; solenoid drivers, displays and indicators.

22. An antenna as claimed in claim 18 including one controller for each peripheral device.

23. An antenna as claimed in claim 18 wherein at least some of the controllers are integrated with peripheral devices.

24. An antenna as claimed in claim 18 wherein the first device is configured to communicate commands or data and address data in packet form when communicating with others of the plurality of controllers.

25. An antenna as claimed in claim 18 including an internal communications bus linking the first controller with the others of the plurality of controllers, the bus supporting an internal communications protocol for packetized, ASCII-based communications between the first device and the controllers, each of the controllers being uniquely software addressable on the internal communications bus.

26. An antenna as claimed in claim 25 wherein the internal communications bus allows plug and play connection of further controllers to the internal communications bus.

27. An antenna as claimed in claim 18, the antenna being a cellular base station antenna.

28. A cellular base station including one or more antennas as claimed in claim 27 controlled by a common remote controller.

29. An antenna including:
i. a plurality of peripheral devices configured to monitor or adjust one or more attributes of the antenna;
ii. a plurality of controllers each associated with one or more of the peripheral devices;
wherein at least one of the controllers is configured to receive an adjustment attribute command and to control an actuator in accordance with the adjustment attribute command.

30. An antenna as claimed in claim 29 wherein the adjustment attribute command specifies a direction in which actuator movement is to be completed.

31. An antenna as claimed in claim 30 wherein the direction specified is one of: in, out, left, right, clockwise or counterclockwise.

32. An antenna as claimed in claim 30 wherein the command also specifies a level of overshoot, the controller being configured, in use, to control an actuator for movement in a first direction different to the specified direction so as to overshoot a desired setting and then return to the desired setting in the specified direction.

33. An antenna as claimed in claim 18 wherein at least some of the distributed intelligent devices perform processing functions for transmission or reception of radiofrequency signals via the antenna's beam.
